(19) United States
(12) Patent Application Publication
(10) Pub. No.: US 2014/0060360 A1
(43) Pub. Date: Mar. 6, 2014

(54) TEXTURED IMAGING MEMBER

(71) Applicants: Carolyn MOORLAG, Mississauga (CA); Timothy D. STOWE, Alameda, CA (US); Nan-Xing HU, Oakville (CA); Gregory B. ANDERSON, Emerald Hills, CA (US)

(72) Inventors: Carolyn MOORLAG, Mississauga (CA); Timothy D. STOWE, Alameda, CA (US); Nan-Xing HU, Oakville (CA); Gregory B. ANDERSON, Emerald Hills, CA (US)

(73) Assignees: PALO ALTO RESEARCH CENTER INC., PALO ALTO, CA (US); XEROX CORPORATION, Norwalk, CT (US)

(21) Appl. No.: 13/601,905

(22) Filed: Aug. 31, 2012

(51) Int. Cl. B41F 1/18; G02B 5/22

(52) U.S. Cl. 101/450.1; 252/582

(57) ABSTRACT

An imaging member includes a surface layer comprising a matrix material, an aerogel component, and a radiation-absorbing filler. Methods of manufacturing the imaging member and processes for variable lithographic printing using the imaging member are also disclosed.

### RELATED APPLICATIONS

The disclosure is related to U.S. patent application Ser. No. 13/095,714, filed on Apr. 27, 2011, titled “Variable Data Lithography System,” the disclosure of which is incorporated herein by reference in its entirety. The disclosure is related to co-pending U.S. patent application Ser. No. ______ (Attorney Docket No. 056-0513), filed on the same day as the present disclosure, titled “Imaging Member for Offset Printing Applications,” the disclosure of which is incorporated herein by reference in its entirety; co-pending U.S. patent application Ser. No. ______ (Attorney Docket No. 056-0512), filed on the same day as the present disclosure, titled “Imaging Member for Offset Printing Applications,” the disclosure of which is incorporated herein by reference in its entirety; co-pending U.S. patent application Ser. No. ______ (Attorney Docket No. 056-0511), filed on the same day as the present disclosure, titled “Imaging Member for Offset Printing Applications,” the disclosure of which is incorporated herein by reference in its entirety; co-pending U.S. patent application Ser. No. ______ (Attorney Docket No. 056-0510), filed on the same day as the present disclosure, titled “Imaging Member for Offset Imaging Applications” the disclosure of which is incorporated herein by reference in its entirety; co-pending U.S. patent application Ser. No. ______ (Attorney Docket No. 056-0508), filed on the same day as the present disclosure, titled “Imaging Member for Offset Printing Applications,” the disclosure of which is incorporated herein by reference in its entirety; co-pending U.S. patent application Ser. No. ______ (Attorney Docket No. 056-0507), filed on the same day as the present disclosure, titled “Variable Lithographic Printing Process,” the disclosure of which is incorporated herein by reference in its entirety; co-pending U.S. patent application Ser. No. ______ (Attorney Docket No. 056-0506), filed on the same day as the present disclosure, titled “Imaging Member for Offset Printing Applications,” the disclosure of which is incorporated herein by reference in its entirety; co-pending U.S. patent application Ser. No. ______ (Attorney Docket No. 056-0505), filed on the same day as the present disclosure, titled “Printing Plates Doped With Release Oils,” the disclosure of which is incorporated herein by reference in its entirety; co-pending U.S. patent application Ser. No. ______ (Attorney Docket No. 056-0504), filed on the same day as the present disclosure, titled “Imaging Member,” the disclosure of which is incorporated herein by reference in its entirety; and co-pending U.S. patent application Ser. No. ______ (Attorney Docket No. 056-0451), filed on the same day as the present disclosure, titled “Methods and Systems for Ink-Based Digital Printing With Multi-Component, Multi-Functional Fountain Solution,” the disclosure of which is incorporated herein by reference in its entirety.

### FIELD OF DISCLOSURE

The present disclosure is related to imaging members having a surface layer as described herein. The imaging members are suitable for use in various marking and printing methods and systems, such as offset printing. Methods of making and using such imaging members are also disclosed.

### BACKGROUND

Offset lithography is a common method of printing today. (For the purposes hereof, the terms “printing” and “marking” are interchangeable.) In a typical lithographic process a printing plate, which may be a flat plate, the surface of a cylinder, or belt, etc., is formed to have “image regions” formed of a hydrophobic/oleophilic material, and “non-image regions” formed of a hydrophilic/oleophobic material. The image regions correspond to the areas on the final print (i.e., the target substrate) that are occupied by a printing or marking material such as ink, whereas the non-image regions correspond to the areas on the final print that are not occupied by said marking material. The hydrophilic regions accept and are readily wetted by a water-based fluid, commonly referred to as a dampening fluid or fountain solution (typically consisting of water and a small amount of alcohol as well as other additives and/or surfactants to reduce surface tension). The hydrophobic regions repel dampening fluid and accept ink, whereas the dampening fluid formed over the hydrophilic regions forms a fluid “release layer” for rejecting ink. The hydrophilic regions of the printing plate thus correspond to unprinted areas, or “non-image areas”, of the final print.

The ink may be transferred directly to a target substrate, such as paper, or may be applied to an intermediate surface, such as an offset (or blanket) cylinder in an offset printing system. The offset cylinder is covered with a conformable coating or sleeve with a surface that can conform to the texture of the target substrate, which may have surface peak-to-valley depth somewhat greater than the surface peak-to-valley depth of the imaging plate. Also, the surface roughness of the offset blanket cylinder helps to deliver a more uniform layer of printing material to the target substrate free of defects such as mottle. Sufficient pressure is used to transfer the image from the offset cylinder to the target substrate. Pinching the target substrate between the offset cylinder and an impression cylinder provides this pressure.

Typical lithographic and offset printing techniques utilize plates which are permanently patterned, and are therefore useful only when printing a large number of copies of the same image (i.e. long print runs), such as magazines, newspapers, and the like. However, they do not permit creating and printing a new pattern from one page to the next without removing and replacing the print cylinder and/or the imaging plate (i.e., the technique cannot accommodate true high speed variable data printing wherein the image changes from impression to impression, for example, as in the case of digital printing systems). Furthermore, the cost of the permanently patterned imaging plates or cylinders is amortized over the number of copies. The cost per printed copy is therefore higher for shorter print runs of the same image than for longer print runs of the same image, as opposed to prints from digital printing systems.

Accordingly, a lithographic technique, referred to as variable data lithography, has been developed which uses a non-patterned reimageable surface that is initially uniformly coated with a dampening fluid layer. Regions of the dampening fluid are removed by exposure to a focused radiation source (e.g., a laser light source) to form pockets. A temporary pattern in the dampening fluid is thereby formed over the non-patterned reimageable surface. Ink applied thereover is retained in the pockets formed by the removal of the dampening fluid. The inked surface is then brought into contact with a substrate, and the ink transfers from the pockets in the dampening fluid layer to the substrate. The dampening fluid may then be removed, a new uniform layer of dampening fluid applied to the reimageable surface, and the process repeated.

It would be desirable to identify alternate materials that are suitable for use for imaging members in variable data lithography.

### BRIEF DESCRIPTION

The present disclosure relates to imaging members for digital offset printing applications. The imaging members have a surface layer including a matrix material, an aerogel component, and a radiation-absorbing filler.

Disclosed in some embodiments is an imaging member comprising a surface layer, wherein the surface layer comprises a matrix material, an aerogel component, and a radiation-absorbing filler.

The aerogel component may comprise a silica aerogel component.

The radiation-absorbing filler may comprise carbon black.

The aerogel component may have a mean particle size of less than about 5 μm. In further embodiments, the aerogel component may have a mean particle size of less than about 1 μm.

The surface layer may comprise from about 0.1 to about 10 wt % of the aerogel component, or from about 1 to about 3 wt % of the aerogel component, or from about 3 to about 10 wt % of the aerogel component. The surface layer may comprise from about 5 to about 15 wt % of the radiation-absorbing filler.

In particular embodiments, the matrix material comprises a silicone; the aerogel component comprises a silica aerogel component; and the radiation-absorbing filler comprises carbon black. In more specific embodiments, the surface layer comprises from about 0.1 to about 10 wt % of the silica aerogel component and from about 5 to about 15 wt % of the carbon black.

The matrix material can be a silicone, a fluorosilicone, or a fluoroelastomer.

The aerogel component may be hydrophobic.

Also disclosed in embodiments is a process for variable lithographic printing, comprising: applying a fountain solution to an imaging member comprising an imaging member surface; forming a latent image by evaporating the fountain solution from selective locations on the imaging member surface to form hydrophobic non-image areas and hydrophilic image areas; developing the latent image by applying an ink composition to the hydrophilic image areas; and transferring the developed latent image to a receiving substrate; wherein the imaging member surface comprises a matrix material, an aerogel component, and a radiation-absorbing filler.

These and other non-limiting aspects and/or objects of the disclosure are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 illustrates a variable lithographic printing apparatus in which the imaging members of the present disclosure may be used.

FIG. 2 illustrates a cross-sectional view of an embodiment of an imaging member of the present disclosure.

FIG. 3A is a top, orthogonal scanning electron micrograph (SEM) of an embodiment of an imaging member of the present disclosure.

FIG. 3B is a top, 45° SEM of the imaging member shown in FIG. 3A.

FIG. 3C is a cross-sectional SEM of the dispersion shown in FIGS. 3A and 3B.

FIG. 4A is a SEM of an exemplary imaging member surface including an un-milled aerogel component.

FIG. 4B is a SEM of an exemplary imaging member surface including a milled aerogel component.

FIG. 4C is a SEM of another exemplary imaging member surface including a milled aerogel component.

FIG. 4D is a SEM of still another exemplary imaging member surface including a milled aerogel component.

FIG. 5A is a SEM of an exemplary imaging member surface including aerogel components having a narrower size distribution than the aerogel component of FIGS. 4A-D.

FIG. 5B is a SEM of an exemplary draw coated imaging member surface including the aerogel component of FIG. 5A.

FIG. 5C is a SEM of the imaging member surface of FIG. 5B after de-agglomeration.

FIG. 6A is a SEM of yet another exemplary imaging member surface of the present disclosure.

FIG. 6B illustrates a print test by hand using the imaging member surface of FIG. 6A.

FIG. 7A is a SEM of still another exemplary imaging member surface of the present disclosure.

FIG. 7B illustrates a print test by hand using the imaging member surface of FIG. 7A.

FIG. 8A is a SEM of another exemplary imaging member surface of the present disclosure.

FIG. 8B illustrates a print test by hand using the imaging member surface of FIG. 8A.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “room temperature” refers to 25° C.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

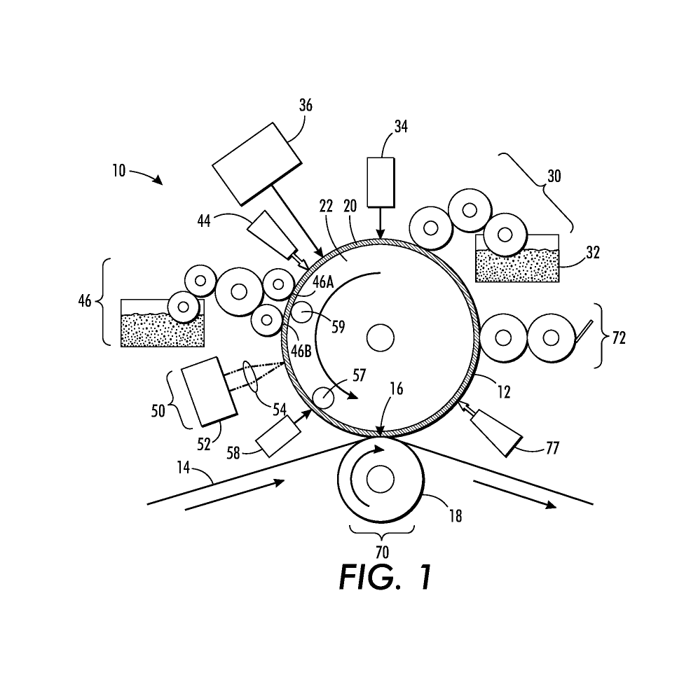

FIG. 1 illustrates a system for variable lithography in which the imaging members of the present disclosure may be used. The system 10 comprises an imaging member 12. The imaging member comprises a substrate 22 and a reimageable surface layer 20. The surface layer is the outermost layer of the imaging member, i.e. the layer of the imaging member furthest from the substrate. As shown here, the substrate 22 is in the shape of a cylinder; however, the substrate may also be in a belt form, etc. Note that the surface layer is usually a different material compared to the substrate, as they serve different functions.

In the depicted embodiment the imaging member 12 rotates counterclockwise and starts with a clean surface. Disposed at a first location is a dampening fluid subsystem 30, which uniformly wets the surface with dampening fluid 32 to form a layer having a uniform and controlled thickness. Ideally the dampening fluid layer is between about 0.15 micrometers and about 1.0 micrometers in thickness, is uniform, and is without pinholes. As explained further below, the composition of the dampening fluid aids in leveling and layer thickness uniformity. A sensor 34, such as an in-situ non-contact laser gloss sensor or laser contrast sensor, is used to confirm the uniformity of the layer. Such a sensor can be used to automate the dampening fluid subsystem 30.

At optical patterning subsystem 36, the dampening fluid layer is exposed to an energy source (e.g. a laser) that selectively applies energy to portions of the layer to image-wise evaporate the dampening fluid and create a latent “negative” of the ink image that is desired to be printed on the receiving substrate. Image areas are created where ink is desired, and non-image areas are created where the dampening fluid remains. An optional air knife 44 is also shown here to control airflow over the surface layer 20 for the purpose of maintaining clean dry air supply, a controlled air temperature, and reducing dust contamination prior to inking. Next, an ink composition is applied to the imaging member using inker subsystem 46. Inker subsystem 46 may consist of a “keyless” system using an anilox roller to meter an offset ink composition onto one or more forming rollers 46A, 46B. The ink composition is applied to the image areas to form an ink image.

A rheology control subsystem 50 partially cures or tacks the ink image. This curing source may be, for example, an ultraviolet light emitting diode (UV-LED) 52, which can be focused as desired using optics 54. Another way of increasing the cohesion and viscosity employs cooling of the ink composition. This could be done, for example, by blowing cool air over the reimageable surface from jet 58 after the ink composition has been applied but before the ink composition is transferred to the final substrate. Alternatively, a heating element 59 could be used near the inker subsystem 46 to maintain a first temperature and a cooling element 57 could be used to maintain a cooler second temperature near the nip 16.

The ink image is then transferred to the target or receiving substrate 14 at transfer subsystem 70. This is accomplished by passing a recording medium or receiving substrate 14, such as paper, through the nip 16 between the impression roller 18 and the imaging member 12.

Finally, the imaging member should be cleaned of any residual ink or dampening fluid. Most of this residue can be easily removed quickly using an air knife 77 with sufficient air flow. Removal of any remaining ink can be accomplished at cleaning subsystem 72.

The imaging member surface generally has a tailored topology. Put another way the surface has a micro-roughened surface structure to help retain fountain solution/dampening fluid in the non-image areas. These hillocks and pits that make up the surface enhance the static or dynamic surface energy forces that attract the fountain solution to the surface. This reduces the tendency of the fountain solution to be forced away from the surface by roller nip action. The imaging member plays multiple roles in the variable data lithography printing process, which include: (1) wetting with the fountain solution, (2) creation of the latent image, (3) inking with the offset ink, and (4) enabling the ink to lift off and be transferred to the receiving substrate. Some desirable qualities for the imaging member, particularly its surface, include high tensile strength to increase the useful service lifetime of the imaging member. The surface layer should also weakly adhere to the ink, yet be wettable with the ink, to promote both uniform inking of image areas and to promote subsequent transfer of the ink from the surface to the receiving substrate.

The imaging members of the present disclosure include a surface layer that meets these requirements. In particular, the surface layer 20 comprises a matrix material and an aerogel component. This allows the surface layer to efficiently absorb energy, which aids in dissipating fountain solution from the image areas in which ink is to be applied. The imaging members of the present disclosure are textured via the inclusion of the aerogel component in a surface layer of the imaging member. The inclusion of the aerogel component eliminates the need for a molding step.

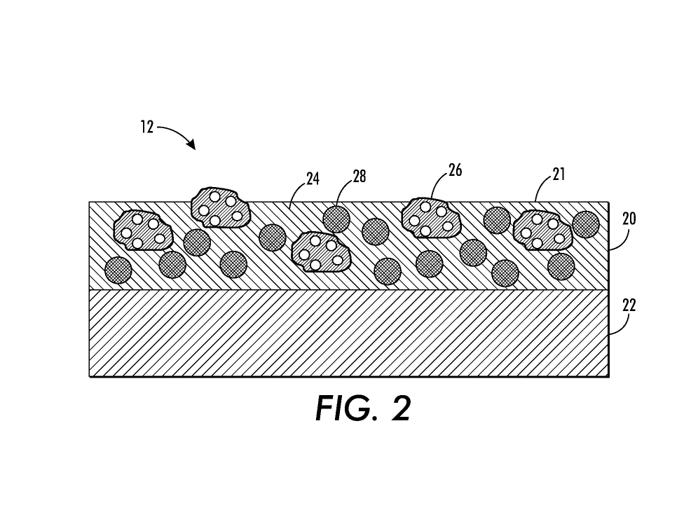

FIG. 2 is a cross-sectional view of an embodiment of an imaging member 12 of the present disclosure. The imaging member 12 includes surface layer 20 and, optionally, a substrate 22. The surface layer 20 includes a matrix 24, an aerogel component 26, and a radiation-absorbing filler 28. The aerogel component 26 and the radiation-absorbing filler 28 may be dispersed in the matrix 24. The dispersion may or may not be homogeneous. In particular embodiments, the aerogel component is concentrated near the external surface 21 of the surface layer 20 opposite the substrate 22. The surface layer should be considered to be the outermost layer of the imaging member. Compositions comprising the matrix 24, aerogel component 26, and radiation-absorbing filler 28 produce texture after coating without the need for a molding step. The compositions allow for simplified control of surface roughness, simplified processing, and reduced production costs.

The matrix may be a silicone, a fluoropolymer, or an elastomer such as ethylene propylene diene polymer. The fluoropolymer may be a fluorosilicone or a fluoroelastomer. The silicone may be a crosslinked silicone. The crosslinked silicone may be cured by moisture or with a platinum catalyst.

The term “fluoroelastomer” refers to a copolymer that contains monomers exclusively selected from the group consisting of hexafluoropropylene (HFP), tetrafluoroethylene (TFE), vinylidene fluoride (VDF), perfluoromethyl vinyl ether (PMVE), and ethylene (ET). The term copolymer here refers to polymers made from two or more monomers. Fluoroelastomers usually contain two or three of these monomers, and have a fluorine content of from about 60 wt % to about 70 wt %. Put another way, a fluoroelastomer has the structure of Formula (I):

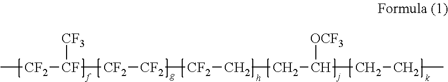

where f is the mole percentage of HFP, g is the mole percentage of TFE, h is the mole percentage of VDF, j is the mole percentage of PMVE, and k is the mole percentage of ET; f+g+h+j+k is 100 mole percent; f, g, h, j, and k can individually be zero, but f+g+h+j must be at least 50 mole percent. Please note that Formula (1) only shows the structure of each monomer and their relative amounts, and should not be construed as describing the bonds within the fluoroelastomer (i.e. not as having five blocks). Fluoroelastomers generally have superior chemical resistance and good physical properties.

The term “silicone” is well understood in the arts and refers to polyorganosiloxanes having a backbone formed from silicon and oxygen atoms and sidechains containing carbon and hydrogen atoms. Other atoms may be present in the silicone rubber, for example nitrogen atoms in amine groups which are used to link siloxane chains together during crosslinking. The sidechains of the polyorganosiloxane are most commonly alkyl or aryl, and may contain other functionalities.

The term “fluorosilicone” refers to polyorganosiloxanes having a backbone formed from silicon and oxygen atoms and sidechains containing carbon, hydrogen, and fluorine atoms. Fluorosilicones normally contain a mixture of alkyl and fluoroalkyl side chains. For example, fluorosilicone may contain a proportion of methyl side chains and a proportion of trifluoropropyl sidechains.

The term “alkyl” as used herein refers to a radical which is composed entirely of carbon atoms and hydrogen atoms which is fully saturated. The alkyl radical may be linear, branched, or cyclic. Linear alkyl radicals generally have the formula —CₙH₂ₙ₊₁.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms).

Desirably, the matrix material is flow coatable, which permits easy manufacturing of the surface layer. In addition, the matrix may be room temperature vulcanizable, or in other words uses a platinum catalyst for curing. In particular embodiments, the matrix material is a poly(dimethyl siloxane) containing functional groups such as silane, halide, or alkene functional groups that permit addition crosslinking.

Any suitable aerogel component can be used. In embodiments, the aerogel component can be, for example, selected from inorganic aerogels, organic aerogels, carbon aerogels, and mixtures thereof. In particular embodiments, ceramic aerogels can be suitably used. These aerogels may be composed of silica, but may also be composed of metal oxides, such as aluminum oxide, or carbon, and can optionally be doped with other elements such as a metal. In some embodiments, the aerogel component can comprise aerogels chosen from polymeric aerogels, colloidal aerogels, and mixtures thereof.

Aerogels may be described, in general terms, as gels that have been dried to a solid phase by removing pore fluid. As used herein, an “aerogel” refers to a material that is generally a very low density solid, typically formed from a gel. The term “aerogel” is thus used to indicate gels that have been dried so that the gel shrinks little during drying, preserving its porosity and related characteristics. In contrast, “hydrogel” is used to describe wet gels in which pore fluids are aqueous fluids. The term “pore fluid” describes fluid contained within pore structures during formation of the pore element(s). Upon drying, such as by supercritical drying, aerogel particles are formed that contain a significant amount of air, resulting in a low density solid and a high surface area. In various embodiments, aerogels are thus low-density microcellular materials characterized by low mass densities, large specific surface areas and very high porosities. In particular, aerogels are characterized by their unique structures that comprise a large number of small inter-connected pores. After the solvent is removed, the polymerized material is pyrolyzed in an inert atmosphere to form the aerogel.

The aerogel component can be either formed initially as the desired sized particles, or can be formed as larger particles and then reduced in size to the desired size. For example, formed aerogel materials can be ground, or they can be directly formed as nano to micron sized aerogel particles.

Aerogel components of embodiments may have porosities of from about 10% to at least about 50%, or more than about 90% to about 99.9%, in which the aerogel can contain 99.9% empty space. For example, the aerogel may suitably have a porosity of from about 50 to about 90% or more, such as from about 55 to about 99%. In embodiments, the pores of aerogel components may have diameters of less than about 500 nm or less than about 50 nm in size. For example, the average pore diameter of the aerogel maybe from about 10 or less to about 100 nm. In particular embodiments, aerogel components may have porosities of more than 50% pores with diameters of less than 100 nm and even less than about 20 nm. In embodiments, the aerogel components may be in the form of particles having a shape that is spherical, or near-spherical, cylindrical, rod-like, bead-like, cubic, platelet-like, and the like.

In embodiments, the aerogel components include aerogel particles, powders, or dispersions ranging in mean particle size of from the sub-micron range to about 5 microns. For example, in embodiments, the aerogel component can have an average volume particle size of from about 50 nm to about 5 μm, such as from about 100 nm or about 500 nm to about 20 μm or about 30 μm. In one particular embodiment, the aerogel component can have an average volume particle size of from about 0 μm to about 5 μm, such as about 1 μm or about 2 μm to about 3 μm or about 5 μm, such as about 4 μm. In embodiments, the aerogel component has a mean particle size of less than about 5 μm, including less than about 3 μm and less than about 1 μm. The aerogel components can include aerogel particles that appear as well dispersed single particles or as agglomerates of more than one particle or groups of particles within the polymer material. The mean particle size and particle size distribution selected may depend on the roughness required for a particular application. The amount of roughness may also be tuned by the amount of aerogel component particles in the surface layer composition.

In some embodiments, the mean particle size of commercially purchased aerogel components is reduced. The reduction may take place via milling, sonication, shear mixing, ball milling, attrition, or any other suitable process. Filtration may be used to narrow the particle size distribution and/or to remove large outlier particles.

Generally, the type, porosity, pore size, and amount of aerogel used for a particular embodiment may be chosen based upon the desired properties of the resultant composition and upon the properties of the polymers and solutions thereof into which the aerogel is being combined. For example, if a pre-polymer (such as a low molecular weight polyurethane monomer that has a relatively low process viscosity, for example less than 10 centistokes) is chosen for use in an embodiment, then a high porosity, for example greater than 80%, and high specific surface area, for example greater than about 500 m²/gram, aerogel having relatively small pore size, for example less than about 50 to about 100 nm, may be mixed at relatively high concentrations, for example greater than about 2 to about 20% by weight, into the pre-polymer by use of moderate-to-high energy mixing techniques, for example by controlled temperature, high shear, blending. If a hydrophilic-type aerogel is used, upon cross-linking and curing/post curing the pre-polymer to form an infinitely long matrix of polymer and aerogel filler, the resultant composite may exhibit improved hydrophobicity and increased hardness when compared to a similarly prepared sample of unfilled polymer. The improved hydrophobicity may be derived from the polymer and aerogel interacting during the liquid-phase processing whereby a portion of the molecular chain of the polymer interpenetrates into the pores of the aerogel and the non-pore regions of the aerogel serves to occupy some or all of the intermolecular space that water molecules could otherwise enter and occupy.

The continuous and monolithic structure of interconnecting pores that characterizes aerogel components also leads to high surface areas and, depending upon the material used to comprise the aerogel, the electrical conductivity may range from highly thermally and electrically conducting to highly thermally and electrically insulating. Further, aerogel components in embodiments may have surface areas ranging from about 400 to about 1200 m²/gram, such as from about 500 to about 1200 m²/gram, or from about 600 to about 800 m²/gram. In embodiments, aerogel components may have electrical resistivities greater than about 1.0×10⁻⁴ Ω-cm, such as in a range of from about 0.01 to about 1.0×10¹⁶ Ω-cm, from about 1 to about 1.0×10⁸ Ω-cm, or from about 50 to about 750,000 Ω-cm. Different types of aerogels used in various embodiments may also have electrical resistivities that span from conductive (about 0.01 to about 1.00 Ω-cm) to insulating, (more than about 10¹⁶ Ω-cm). Conductive aerogels, such as carbon aerogels, may be combined with other conductive fillers to produce combinations of physical, mechanical, and electrical properties that are otherwise difficult to obtain.

Aerogels that can suitably be used in embodiments may be divided into three major categories: inorganic aerogels, organic aerogels, and carbon aerogels. In embodiments, the imaging member layer may contain one or more aerogels chosen from inorganic aerogels, organic aerogels, carbon aerogels and mixtures thereof. For example, embodiments can include multiple aerogels of the same type, such as combinations of two or more inorganic aerogels, combinations of two or more organic aerogels, or combinations of two or more carbon aerogels, or can include multiple aerogels of different types, such as one or more inorganic aerogels, one or more organic aerogels, and/or one or more carbon aerogels. For example, a chemically modified, hydrophobic silica aerogel may be combined with a high electrical conductivity carbon aerogel to simultaneously modify the hydrophobic and electrical properties of a composite and achieve a desired target level of each property.

Inorganic aerogels, such as silica aerogels, are generally formed by sol-gel polycondensation of metal oxides to form highly cross-linked, transparent hydrogels. These hydrogels are subjected to supercritical drying to form inorganic aerogels.

The silica aerogel particles may be hydrophobic, surface treated, and dispersed efficiently throughout the matrix. Due to the low density of silica aerogel, particles do not recede to the bottom of a composite dispersion, and rather will disperse through the layer and at the surface to form a prominent texture on the approximate roughness scale of the particle sizes. Carbon black particles of sub-micron particle size may be included in the materials composition for the absorption of laser light required to evaporate fountain solution on the imaging member surface. Other fillers or additives may be added to the materials composition to enable other materials requirements for digital offset printing, such as fillers to improve robustness or dispersants to promote dispersion. The matrix material may be a polymeric matrix of crosslinked silicone, including moisture-cured silicone or platinum-cured silicone, a fluoroelastomer crosslinked fluoropolymer such as VITON® (commercially available from DuPont), or other elastomers such as ethylene-propylene diene polymer.

Organic aerogels are generally formed by sol-gel polycondensation of resorcinol and formaldehyde. These hydrogels are subjected to supercritical drying to form organic aerogels.

Carbon aerogels are generally formed by pyrolyzing organic aerogels in an inert atmosphere. Carbon aerogels are composed of covalently bonded, nanometer-sized particles that are arranged in a three-dimensional network. Carbon aerogels, unlike high surface area carbon powders, have oxygen-free surfaces, which can be chemically modified to increase their compatibility with polymer matrices. In addition, carbon aerogels are generally electrically conductive, having electrical resistivities of from about 0.005 to about 1.00 Ω-cm.

In addition, the porous aerogel particles may interpenetrate or intertwine with the polymer and thereby strengthen the polymeric lattice. The mechanical properties of the overall composite of embodiments in which aerogel particles have interpenetrated or interspersed with the polymeric lattice may thus be enhanced and stabilized.

For example, in some embodiments, the aerogel component can be a silica silicate having an average particle size of from about 5 to about 15 μm, a porosity of 90% or more, a bulk density of from about 40 to about 100 kg/m³, and/or a surface area of from about 600 to about 800 m²/gram. Of course, materials having one or more properties outside of these ranges can be used, as desired.

Silica aerogel particles may impart texture to the surface layer on the scale of the particles, i.e. on the micron scale, and on the scale of the pores. The pores may include micropores, mesopores, and/or macropores. Micropores have a size of less than 2 nanometers. Mesopores have a size of from 2 to 50 nanometers. Macropores have a size of greater than 50 nanometers. In some embodiments, a majority of the pores are mesopores.

Depending upon the properties of the aerogel components, the aerogel components can be used as is, or they can be chemically modified. For example, in particular embodiments, aerogel surface chemistries may be modified for various applications, for example, the aerogel surface may be modified by chemical substitution upon or within the molecular structure of the aerogel to have hydrophilic or hydrophobic properties. For example, chemical modification may be desired so as to improve the hydrophobicity of the aerogel components. When such chemical treatment is desired, any conventional chemical treatment well known in the art can be used. For example, such chemical treatments of aerogel powders can include replacing surface hydroxyl groups with organic or partially fluorinated organic groups, or the like. Surface treatments with silyl groups are also contemplated.

Advantages of a hydrophobic aerogel component include (1) decreased potential for surface contamination; (2) excellent dispersion of particles; and (3) increased propensity for particles to protrude at the surface to produce texture. To achieve a high level of hydrophobicity, the aerogel component should be combined with the matrix material so that the hydrophobic aerogel particles are included in a sufficient proportion to reduce contamination at the surface of the imaging member, which contamination could include toner components, paper additives, or the like. In particular embodiments, the aerogel component is provided in a minimum amount necessary to provide the desired results.

In general, a wide range of aerogel components are known in the art and have been applied in a variety of uses. For example, many aerogel components, including ground hydrophobic aerogel particles, have been used as low cost additives in such formulations as hair, skincare, and antiperspirant compositions. One specific non-limiting example is a commercially available powder that has already been chemically treated, Dow Corning VM-2270 Aerogel fine particles having a size of from about 5 to about 15 microns.

In embodiments, the surface layer may comprise at least the above-described aerogel that is at least one of dispersed in or bonded to the matrix material. In particular embodiments, the aerogel is uniformly dispersed in and/or bonded to the matrix material, although non-uniform dispersion or bonding can be used in embodiments to achieve specific goals. For example, in embodiments, the aerogel can be non-uniformly dispersed or bonded in the matrix material to provide a higher concentration of the aerogel at the surface of the surface layer compared to within the surface layer. The concentration of aerogel at the surface may occur naturally due to the lower density of the aerogel relative to the matrix material.

Any suitable amount of the aerogel may be incorporated into the matrix material, to provide desired results. For example, the surface layer may contain from about 0.1 to about 10 wt % of the aerogel component. In some embodiments, the surface layer includes from about 1 to about 3 wt % of the aerogel component. Inclusion of aerogel component particles in the amount and size disclosed (1) improves mechanical properties; and (2) reduces the likelihood of surface particles being extracted.

The aerogel component may be dispersed evenly throughout the matrix. Due to low density, the aerogel component may form a prominent texture on the surface. The roughness of the surface texture may be controlled to approximately the 1 micron range to ensure efficient transfer of ink to the receiving substrate. A plate surface that is not textured enough will not efficiently wet ink on the plate surface, resulting in inhomogeneous ink coverage. Known approaches to providing texture require molding to a template, but this process is labor intensive and does not allow for coating the desired composition directly onto a substrate, such as onto a commercial offset blanket. The present approach for creating texture allows more latitude for materials processing and imaging member manufacturing.

The surface layer may include a radiation-absorbing filler. The radiation-absorbing filler may be carbon black, graphene, multiwalled carbon nanotubes, carbon aerogel, nanosized metal particles, or a metal oxide. The metal oxide may be iron oxide.

The radiation-absorbing filler may have an average particle size in the sub-micron scale. The filler is included to absorb radiation, e.g. laser light radiation, to evaporate fountain solution on the imaging member surface.

Other fillers may also be included. For example, fillers to improve robustness or dispersants to promote dispersion may be included.

The surface layer composition may be provided in a surface layer coating solution. The surface layer coating solution may also contain a surfactant, if desired. Any suitable and known surfactant, or mixture of two or more surfactants, can be used. When present, the surfactant can be incorporated into the surface layer coating solution in any desired amount, such as to provide a coating solution that achieves defect-free or substantially defect-free coatings. In embodiments, the amount of surfactant included in the coating solution can be, for example, from about 0.01 or from about 0.1 to about 10 or to about 15% by weight, such as from about 0.5 to about 5% or to about 6% by weight of the coating solution.

The surface layer may be prepared in a mold as a 1 to 2 millimeter thick layer or coated onto a substrate as a 10 to 30 micron thick layer. Due to self-organization of the surface, a molding step is not required to add surface texture.

Further disclosed are processes for variable lithographic printing. The processes include applying a fountain solution/dampening fluid to an imaging member comprising an imaging member surface. A latent image is formed by evaporating the fountain solution from selective locations on the imaging member surface to form hydrophobic non-image areas and hydrophilic image areas; developing the latent image by applying an ink composition to the hydrophilic image areas; and transferring the developed latent image to a receiving substrate. The imaging member surface comprises a matrix material and an aerogel component.

The present disclosure contemplates a system where the dampening fluid is hydrophobic (i.e. non-aqueous) and the ink somewhat hydrophilic (having a small polar component). This system can be used with the imaging member surface layer of the present disclosure. Generally speaking, the variable lithographic system can be described as comprising an ink composition, a dampening fluid, and an imaging member surface layer, wherein the dampening fluid has a surface energy alpha-beta coordinate which is within the circle connecting the alpha-beta coordinates for the surface energy of the ink and the surface energy of the imaging member surface layer. In particular embodiments, the dampening fluid has a total surface tension greater than 15 dynes/cm and less than 30 dynes/cm with a polar component of less than 5 dynes/cm. The imaging member surface layer may have a surface tension of less than 30 dynes/cm with a polar component of less than 2 dynes/cm.

By choosing the proper chemistry, it is possible to devise a system where both the ink and the dampening fluid will wet the imaging member surface, but the ink and the dampening fluid will not mutually wet each other. The system can also be designed so that it is energetically favorable for dampening fluid in the presence of ink residue to actually lift the ink residue off of the imaging member surface by having a higher affinity for wetting the surface in the presence of the ink. In other words, the dampening fluid could remove microscopic background defects (e.g. <1 μm radius) from propagating in subsequent prints.

The dampening fluid should have a slight positive spreading coefficient so that the dampening fluid wets the imaging member surface. The dampening fluid should also maintain a spreading coefficient in the presence of ink, or in other words the dampening fluid has a closer surface energy value to the imaging member surface than the ink does. This causes the imaging member surface to value wetting by the dampening fluid compared to the ink, and permits the dampening fluid to lift off any ink residue and reject ink from adhering to the surface where the laser has not removed dampening fluid. Next, the ink should wet the imaging member surface in air with a roughness enhancement factor (i.e. when no dampening fluid is present on the surface). It should be noted that the surface may have a roughness of less than 1 μm when the ink is applied at a thickness of 1 to 2 μm. Desirably, the dampening fluid does not wet the ink in the presence of air. In other words, fracture at the exit inking nip should occur where the ink and the dampening fluid interface, not within the dampening fluid itself. This way, dampening fluid will not tend to remain on the imaging member surface after ink has been transferred to a receiving substrate. Finally, it is also desirable that the ink and dampening fluid are chemically immiscible such that only emulsified mixtures can exist. Though the ink and the dampening fluid may have alpha-beta coordinates close together, often choosing the chemistry components with different levels of hydrogen bonding can reduce miscibility by increasing the difference in the Hanson solubility parameters.

The role of the dampening fluid is to provide selectivity in the imaging and transfer of ink to the receiving substrate. When an ink donor roll in the ink source of FIG. 1 contacts the dampening fluid layer, ink is only applied to areas on the imaging member that are dry, i.e. not covered with dampening fluid.

It is contemplated that the dampening fluid which is compatible with the ink compositions of the present disclosure is a volatile hydrofluoroether (HFE) liquid or a volatile silicone liquid. These classes of fluids provides advantages in the amount of energy needed to evaporate, desirable characteristics in the dispersive/polar surface tension design space, and the additional benefit of zero residue left behind once evaporated. The hydrofluoroether and silicone are liquids at room temperature, i.e. 25° C.

In specific embodiments, the volatile hydrofluoroether liquid has the structure of Formula (I):

CₘHₚF₂ₘ₊₁₋ₚ—O—CₙH_{q}F_{2n+1-q} Formula (I)

wherein m and n are independently integers from 1 to about 9; and p and q are independently integers from 0 to 19. As can be seen, generally the two groups bound to the oxygen atom are fluoroalkyl groups.

In particular embodiments, q is zero and p is non-zero. In these embodiments, the right-hand side of the compound of Formula (I) becomes a perfluoroalkyl group. In other embodiments, q is zero and p has a value of 2 m+1. In these embodiments, the right-hand side of the compound of Formula (I) is a perfluoroalkyl group and the left-hand side of the compound of Formula (I) is an alkyl group. In still other embodiments, both p and q are at least 1.

In this regard, the term “fluoroalkyl” as used herein refers to a radical which is composed entirely of carbon atoms and hydrogen atoms, in which one or more hydrogen atoms may be (i.e. are not necessarily) substituted with a fluorine atom, and which is fully saturated. The fluoroalkyl radical may be linear, branched, or cyclic. It should be noted that an alkyl group is a subset of fluoroalkyl groups.

The term “perfluoroalkyl” as used herein refers to a radical which is composed entirely of carbon atoms and fluorine atoms which is fully saturated and of the formula —CₙF₂ₙ₊₁. The perfluoroalkyl radical may be linear, branched, or cyclic. It should be noted that a perfluoroalkyl group is a subset of fluoroalkyl groups, and cannot be considered an alkyl group.

In particular embodiments, the hydrofluoroether has the structure of any one of Formulas (I-a) through (I-h):

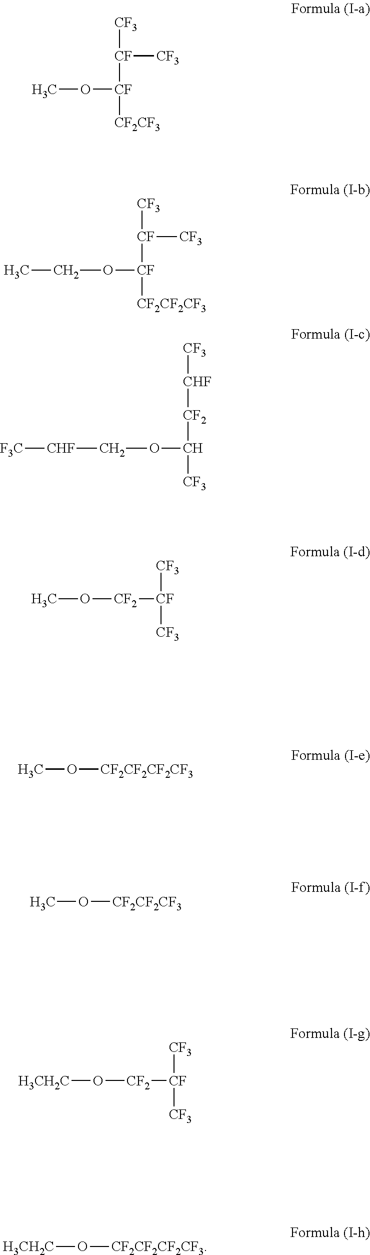

Of these formulas, Formulas (I-a), (I-b), (I-d), (I-e), (I-f), (I-g), and (I-h) have one alkyl group and one perfluoroalkyl group, either branched or linear. In some terminology, they are also called segregated hydrofluoroethers. Formula (I-c) contains two fluoroalkyl groups and is not considered a segregated hydrofluoroether.

Formula (I-a) is also known as 1,1,1,2,2,3,4,5,5,5-decafluoro-3-methoxy-4-(trifluoromethyl)pentane and has CAS#132182-92-4. It is commercially available as Novec™ 7300.

Formula (I-b) is also known as 3-ethoxy-1,1,1,2,3,4,4,5,5,6,6,6-dodecafluoro-2-(trifluoromethyl)hexane and has CAS#297730-93-9. It is commercially available as Novec™ 7500.

Formula (I-c) is also known as 1,1,1,2,3,3-Hexafluoro-4-(1,1,2,3,3,3-hexafluoropropoxy)pentane and has CAS#870778-34-0. It is commercially available as Novec™ 7600.

Formula (I-d) is also known as methyl nonafluoroisobutyl ether and has CAS#163702-08-7. Formula (I-e) is also known as methyl nonafluorobutyl ether and has CAS#163702-07-6. A mixture of Formulas (I-d) and (I-e) is commercially available as Novec™ 7100. These two isomers are inseparable and have essentially identical properties.

Formula (I-f) is also known as 1-methoxyheptafluoropropane or methyl perfluoropropyl ether, and has CAS#375-03-1. It is commercially available as Novec™ 7000.

Formula (I-g) is also known as ethyl nonafluoroisobutyl ether and has CAS#163702-05-4. Formula (I-h) is also known as ethyl nonafluorobutyl ether and has CAS#163702-06-5. A mixture of Formulas (I-g) and (I-h) is commercially available as Novec™ 7200 or Novec™ 8200. These two isomers are inseparable and have essentially identical properties.

It is also possible that similar compounds having a cyclic aromatic backbone with perfluoroalkyl sidechains can be used. In particular, compounds of Formula (A) are contemplated:

Ar—(CₖF₂ₖ₊₁)ₜ Formula (A)

wherein Ar is an aryl or heteroaryl group; k is an integer from 1 to about 9; and t indicates the number of perfluoroalkyl sidechains, t being from 1 to about 8.

The term “heteroaryl” refers to a cyclic radical composed of carbon atoms, hydrogen atoms, and a heteroatom within a ring of the radical, the cyclic radical being aromatic. The heteroatom may be nitrogen, sulfur, or oxygen. Exemplary heteroaryl groups include thienyl, pyridinyl, and quinolinyl. When heteroaryl is described in connection with a numerical range of carbon atoms, it should not be construed as including substituted heteroaromatic radicals. Note that heteroaryl groups are not a subset of aryl groups.

Hexafluoro-m-xylene (HFMX) and hexafluoro-p-xylene (HFPX) are specifically contemplated as being useful compounds of Formula (A) that can be used as low-cost dampening fluids. HFMX and HFPX are illustrated below as Formulas (A-a) and (A-b):

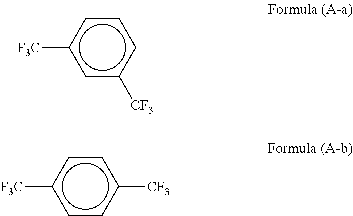

It should be noted any co-solvent combination of fluorinated damping fluids can be used to help suppress non-desirable characteristics such as a low flammability temperature.

Alternatively, the dampening fluid solvent is a volatile silicone liquid. In some embodiments, the volatile silicone liquid is a linear siloxane having the structure of Formula (II):

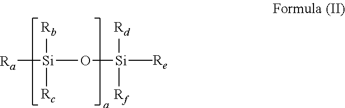

wherein Rₐ, R_{b}, R_{c}, R_{d}, Rₑ, and R_{f} are each independently hydrogen, alkyl, or perfluoroalkyl; and a is an integer from 1 to about 5. In some specific embodiments, Rₐ, R_{b}, R_{c}, R_{d}, Rₑ, and R_{f} are all alkyl. In more specific embodiments, they are all alkyl of the same length (i.e. same number of carbon atoms).

Exemplary compounds of Formula (II) include hexamethyldisiloxane and octamethyltrisiloxane, which are illustrated below as Formulas (II-a) and (II-b):

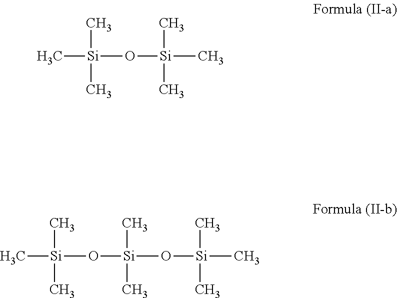

In other embodiments, the volatile silicone liquid is a cyclosiloxane having the structure of Formula (III):

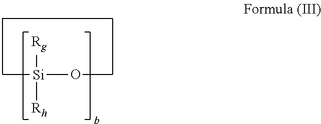

wherein each R_{g} and Rₕ is independently hydrogen, alkyl, or perfluoroalkyl; and b is an integer from 3 to about 8. In some specific embodiments, all of the R_{g} and Rₕ groups are alkyl. In more specific embodiments, they are all alkyl of the same length (i.e. same number of carbon atoms).

Exemplary compounds of Formula (III) include octamethylcyclotetrasiloxane (aka D4) and decamethylcyclopentasiloxane (aka D5), which are illustrated below as Formulas (III-a) and (III-b):

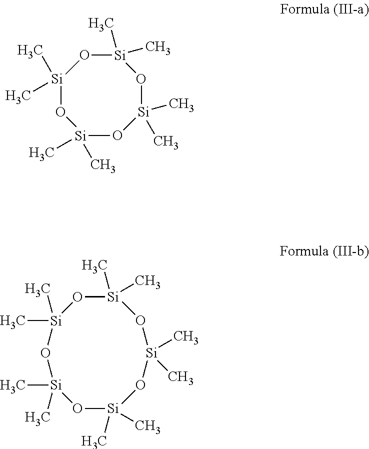

In other embodiments, the volatile silicone liquid is a branched siloxane having the structure of Formula (IV):

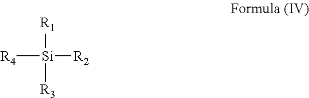

wherein R₁, R₂, R₃, and R₄ are independently alkyl or —OSiR₁R₂R₃.

An exemplary compound of Formula (IV) is methyl trimethicone, also known as methyltris(trimethylsiloxy)silane, which is commercially available as TMF-1.5 from Shin-Etsu, and shown below with the structure of Formula (IV-a):

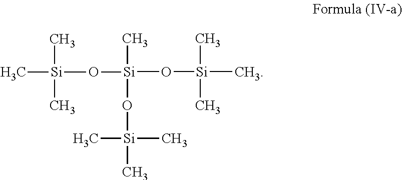 [SMILES: C[Si](C)(C)O[Si](C)(O[Si](C)(C)C)O[Si](C)(C)C]

Any of the above described hydrofluoroethers/perfluorinated compounds are miscible with each other. Any of the above described silicones are also miscible with each other. This allows for the tuning of the dampening fluid for optimal print performance or other characteristics, such as boiling point or flammability temperature. Combinations of these hydrofluoroether and silicone liquids are specifically contemplated as being within the scope of the present disclosure. It should also be noted that the silicones of Formulas (II), (III), and (IV) are not considered to be polymers, but rather discrete compounds whose exact formula can be known.

In particular embodiments, it is contemplated that the dampening fluid comprises a mixture of octamethylcyclotetrasiloxane (D4) and decamethylcyclopentasiloxane (D5). Most silicones are derived from D4 and D5, which are produced by the hydrolysis of the chlorosilanes produced in the Rochow process. The ratio of D4 to D5 that is distilled from the hydrolysate reaction is generally about 85% D4 to 15% D5 by weight, and this combination is an azeotrope.

In particular embodiments, it is contemplated that the dampening fluid comprises a mixture of octamethylcyclotetrasiloxane (D4) and hexamethylcyclotrisiloxane (D3), the D3 being present in an amount of up to 30% by total weight of the D3 and the D4. The effect of this mixture is to lower the effective boiling point for a thin layer of dampening fluid.

These volatile hydrofluoroether liquids and volatile silicone liquids have a low heat of vaporization, low surface tension, and good kinematic viscosity.

The ink compositions contemplated for use with the present disclosure generally include a colorant and a plurality of selected crosslinkable compounds. The crosslinkable compounds can be cured under ultraviolet (UV) light to fix the ink in place on the final receiving substrate. As used herein, the term “colorant” includes pigments, dyes, quantum dots, mixtures thereof, and the like. Dyes and pigments have specific advantages. Dyes have good solubility and dispersibility within the ink vehicle. Pigments have excellent thermal and light-fast performance. The colorant is present in the ink composition in any desired amount, and is typically present in an amount of from about 10 to about 40 weight percent (wt %), based on the total weight of the ink composition, or from about 20 to about 30 wt %. Various pigments and dyes are known in the art, and are commercially available from suppliers such as Clariant, BASF, and Ciba, to name just a few.

The ink compositions may have a viscosity of from about 5,000 to about 40,000 centipoise at 25° C. and infinite shear, including a viscosity of from about 7,000 to about 15,000 cps. These ink compositions may also have a surface tension of at least about 25 dynes/cm at 25° C., including from about 25 dynes/cm to about 40 dynes/cm at 25° C. These ink compositions possess many desirable physical and chemical properties. They are compatible with the materials with which they will come into contact, such as the dampening fluid, the surface layer of the imaging member, and the final receiving substrate. They also have the requisite wetting and transfer properties. They can be UV-cured and fixed in place. They also have a good viscosity; conventional offset inks usually have a viscosity above 50,000 cps, which is too high to use with nozzle-based inkjet technology. In addition, one of the most difficult issues to overcome is the need for cleaning and waste handling between successive digital images to allow for digital imaging without ghosting of previous images. These inks are designed to enable very high transfer efficiency instead of ink splitting, thus overcoming many of the problems associated with cleaning and waste handling. The ink compositions of the present disclosure do not gel, whereas regular offset inks made by simple blending do gel and cannot be used due to phase separation.

Aspects of the present disclosure may be further understood by referring to the following examples. The examples are illustrative, and are not intended to be limiting embodiments thereof.

### EXAMPLES

VM-2270 (commercially available from Dow Corning) was used for the aerogel component in some of the examples. VM-2270 is a silica silicate aerogel powder containing particles having sizes of from 5 to 15 μm, greater than 90% porosity, 40 to 100 kg/m³ bulk density, and 600 to 800 m²/g specific surface area. In some cases, the particles were milled down to smaller particle sizes. The milling was performed with stainless steel milling media.

A silica aerogel having a mean particle size of about 1.3 μm was obtained from Cabot and used for some of the other examples.

The matrix used in the examples was a silicone polymer known as Toray SE 9187 L Black Silicone (commercially available from Dow Corning). This silicone contained trimethoxysiloxy-terminated dimethyl siloxane, trimethylated silica, and trimethoxymethylsilane.

As a filler material, Vulcan XC72R Carbon Black was used.

In some of the Examples, stainless steel milling media was used to deagglomerate carbon black particles (18 hours in toluene) and Cabot's aerogel particles (0.5 hours in toluene).

### Coatings Preparation

Dispersions were prepared containing Toray silicone, 100 to 200 pph toluene, 3 to 10 pph silica aerogel, and 0 to 10 ppm carbon black. The dispersions were either (1) cast into molds with thicknesses of from about 2 to about 3 mm on Teflon paper substrates; or (2) draw-down coated onto aluminum paper. Following molding or coating, the toluene was removed by evaporation in nitrogen ambient for 2 hours. The example layers were cured in air overnight.

### Example 1

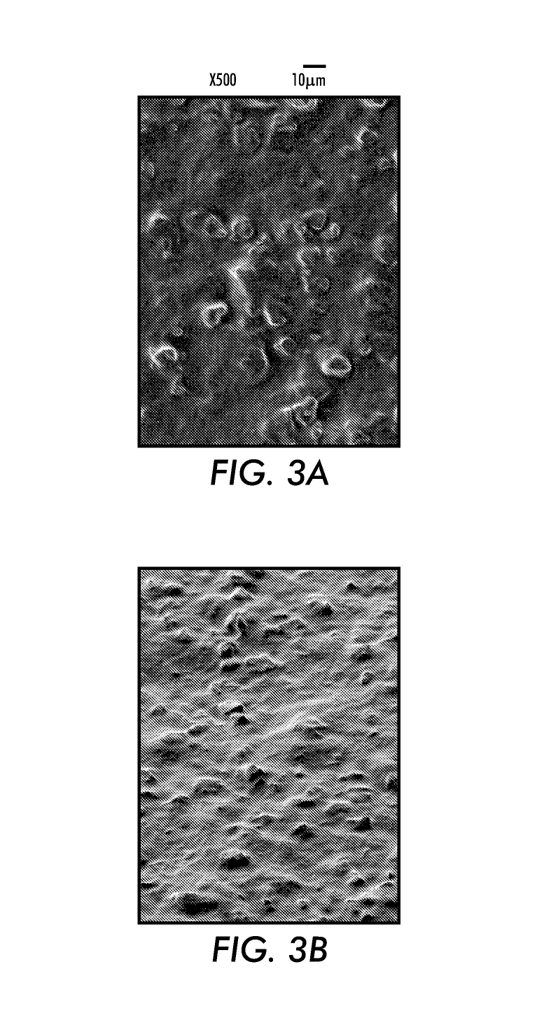

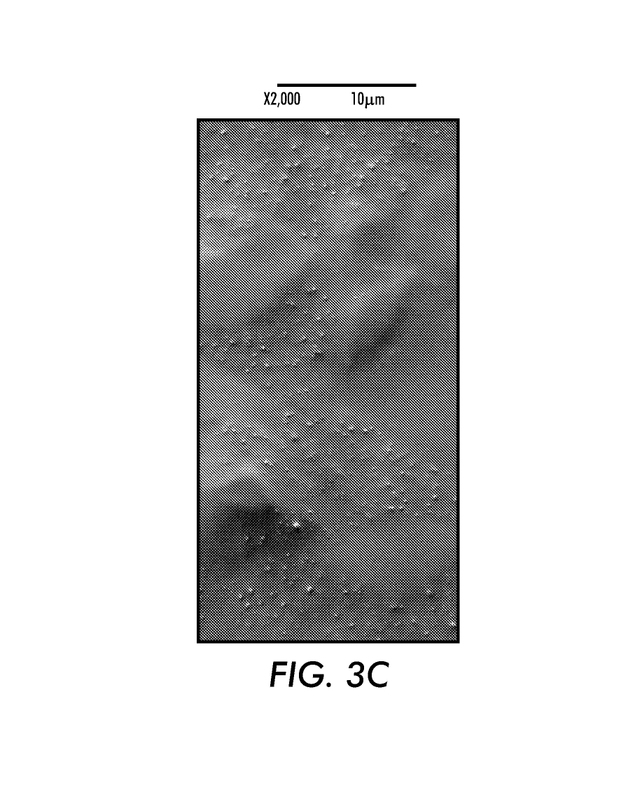

In Example 1, the surface layer comprised silicone, 3 wt % silica aerogel, and 10 wt % carbon black. The silica aerogel had an average particle size of about 10 μm. FIGS. 3A-C are SEM images from a top, orthogonal view, a top 45° view, and a cross-sectional view, respectively. The SEM images show that the roughness produced at the surface is approximately on a 10 μm scale, which was the same as the average particle size of the aerogel component. The submicron-sized carbon black particles can be observed as being dispersed between the silica aerogel particles in FIG. 3C.

Test surfaces containing silica aerogel were matte in appearance versus control samples lacking an aerogel component that were shiny in appearance. The surfaces with and without aerogel were smooth and level. The aerogel test surface layers exhibited higher cohesion and strength when stretched and were less prone to tearing. The addition of silica aerogel particles to silicone resulted in an increase in tensile strength.

### Example 2

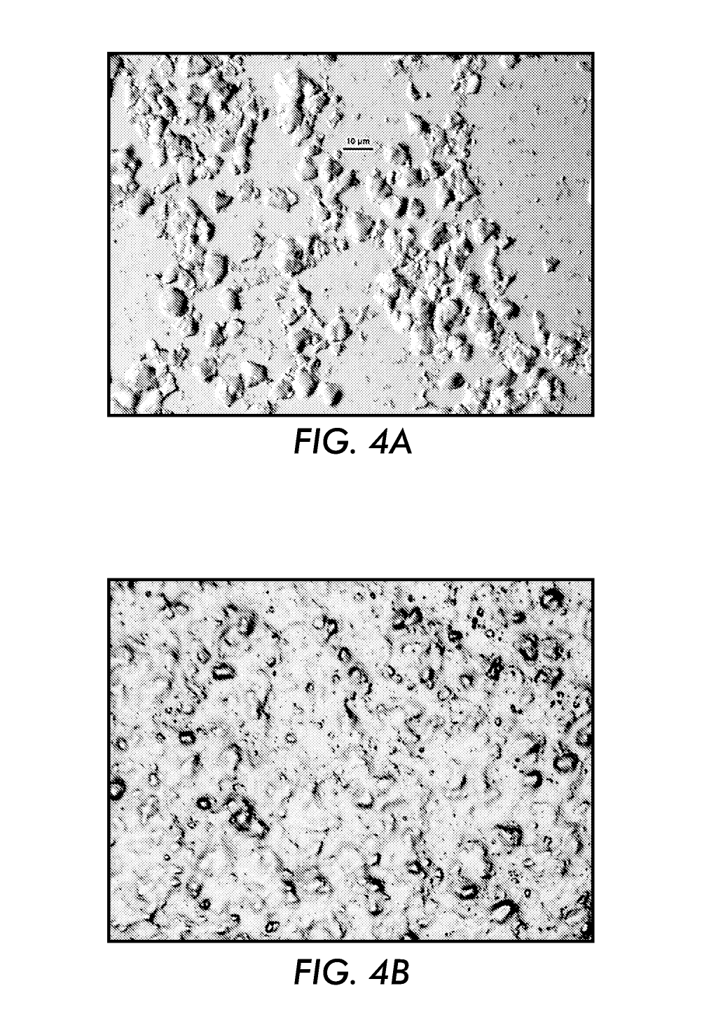

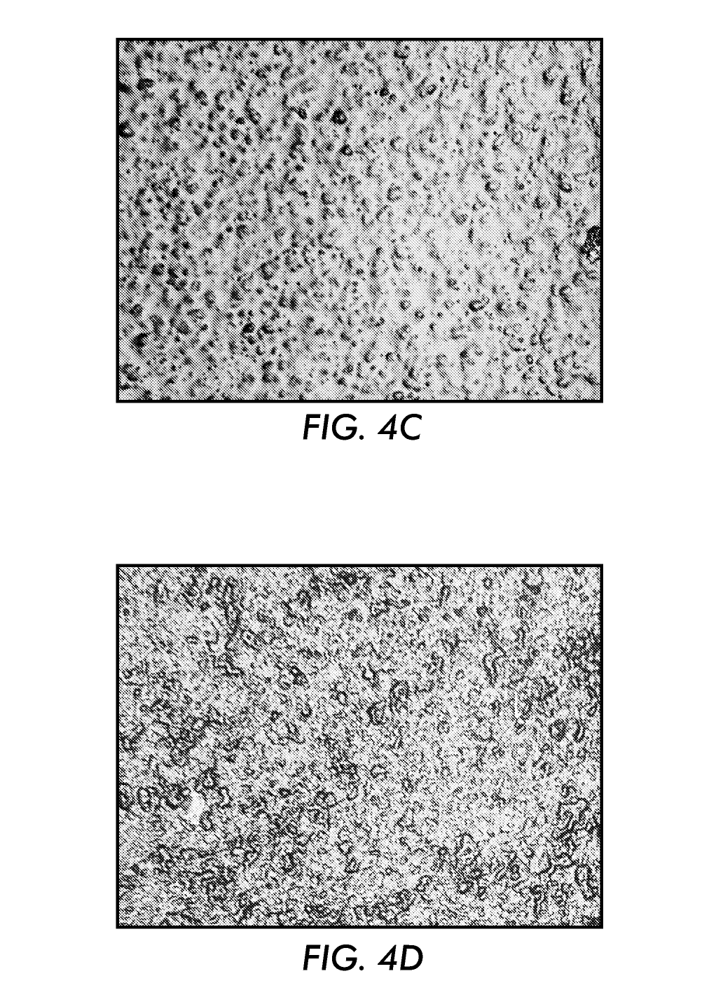

In Example 2, the surface layer comprised silicone and 3 wt % silica aerogel. The silica aerogel had a mean particle size of 10 μm and was not milled. FIG. 4A is a SEM of the surface layer.

### Example 3

In Example 3, the procedure of Example 2 was followed except that the silica aerogel particles were milled in toluene for about 0.5 hours. Milling was performed for about 0.5 hours in toluene to achieve a mean particle size of about 2.5 μm. The milled particles had a mean particle size of about 2.5 μm. FIG. 4B is a SEM of the surface layer. SEM imaging of the surface indicated a particle size range which included larger particles. These larger particles could have been removed by sieving.

### Example 4

In Example 4, the procedure of Example 2 was followed except that the silica aerogel particles were milled in toluene for about 1.5 hours. The milled particles had a mean particle size of about 1.5 μm. FIG. 4C is a SEM image of the surface layer. SEM imaging of the surface indicated fewer large-sized particles and a denser distribution of particle on the surface.

### Example 5

In Example 5, the procedure of Example 4 was followed except that 10 wt % silica aerogel was utilized. The milled particles had a mean particle size of about 1.5 μm. FIG. 4C is a SEM image of the surface layer. Observation of the surface indicated a far denser distribution of particles on the surface.

The results of Examples 2-4 indicated that milling time correlates to the size of the texture obtained on the surface and increased loading increases the degree of texture on the surface.

### Example 6

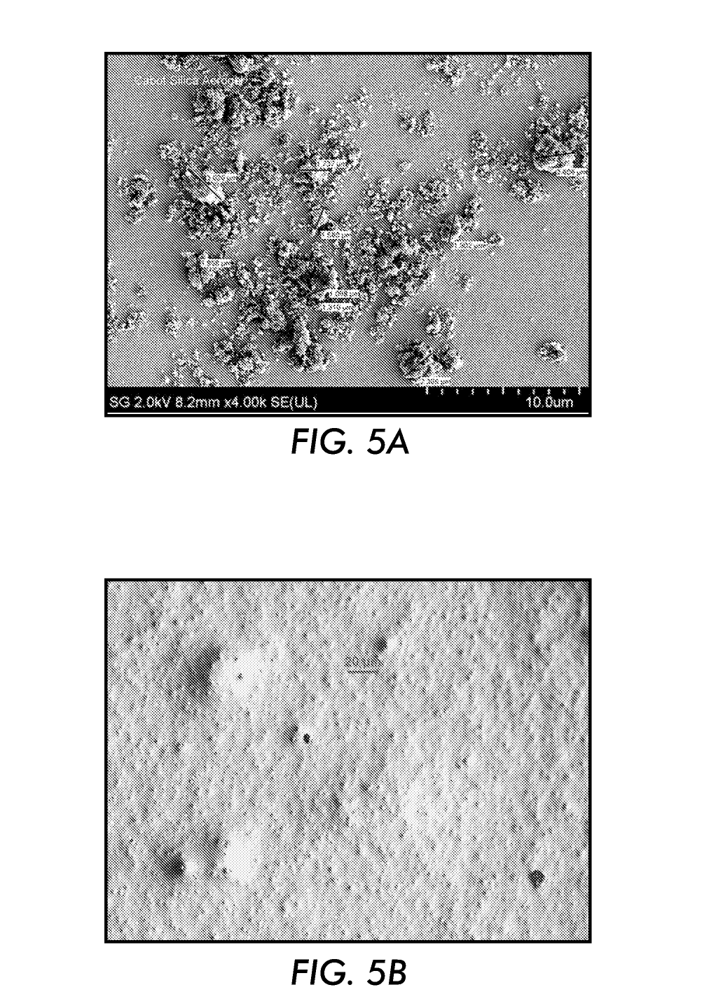

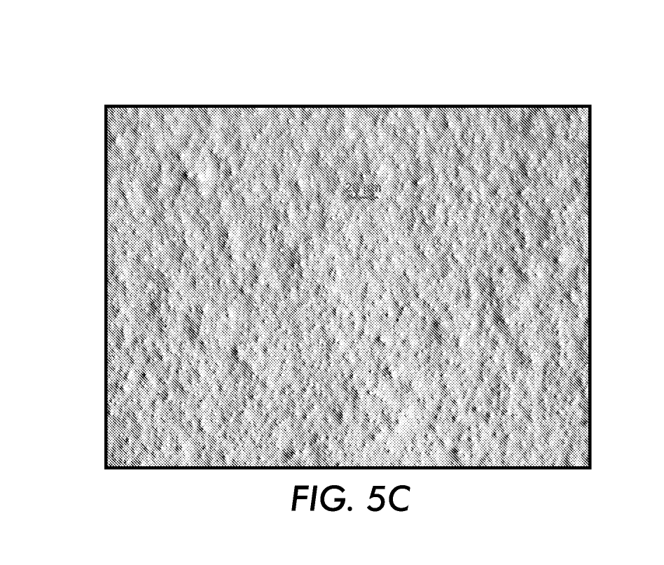

In Example 6, the surface layer included silicone and 3 wt % of silica aerogel particles having a mean particle size of 1.3 μm and a narrower particle size distribution that the particles used in Examples 1-5. FIG. 5A is a SEM image of the particles. A dispersion of the particles was directly mixed with the silicone to produce a surface with agglomerated sections. FIG. 5B is a SEM image of the agglomerated surface. De-agglomeration of the particles yielded a surface without agglomerated sections, and with increased density of particles on the surface.

### Example 7

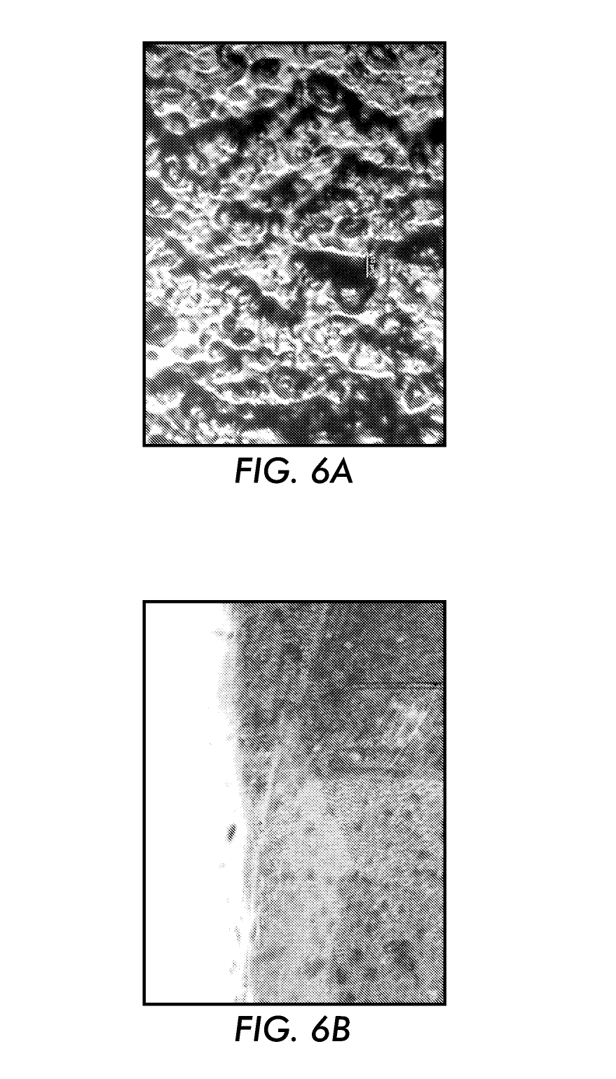

In Example 7, an imaging member surface layer comprising silicone, 10 wt % silica aerogel particles, and no carbon black was hand tested. The aerogel particles originally had a mean particle size of about 10 μm but were milled for about 1.5 hours. FIG. 6A is an SEM image of the surface layer.

The hand testing was performed by applying Novec fountain solution to the surface; applying viscous offset ink using a hand roller; and transferring prints to paper. FIG. 6B is a picture of the print using the surface layer shown in FIG. 6A.

### Example 8

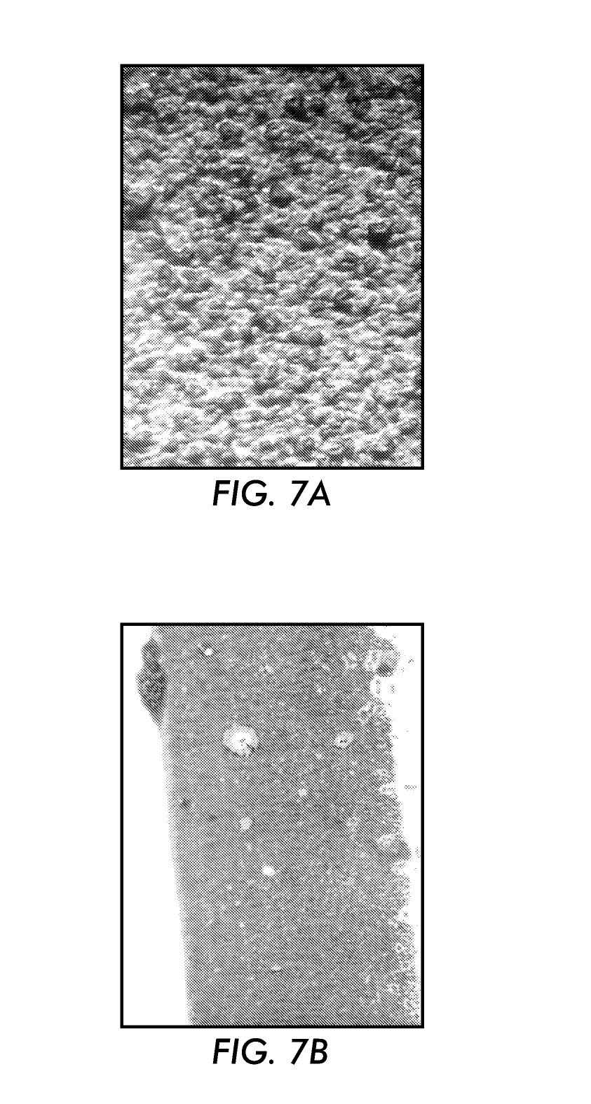

In Example 8, the procedure of Example 7 was followed except that a de-agglomeration step was also included. FIG. 7A is an SEM image of the surface layer. FIG. 7B is a picture of the print using the surface layer shown in FIG. 7A.

### Example 9

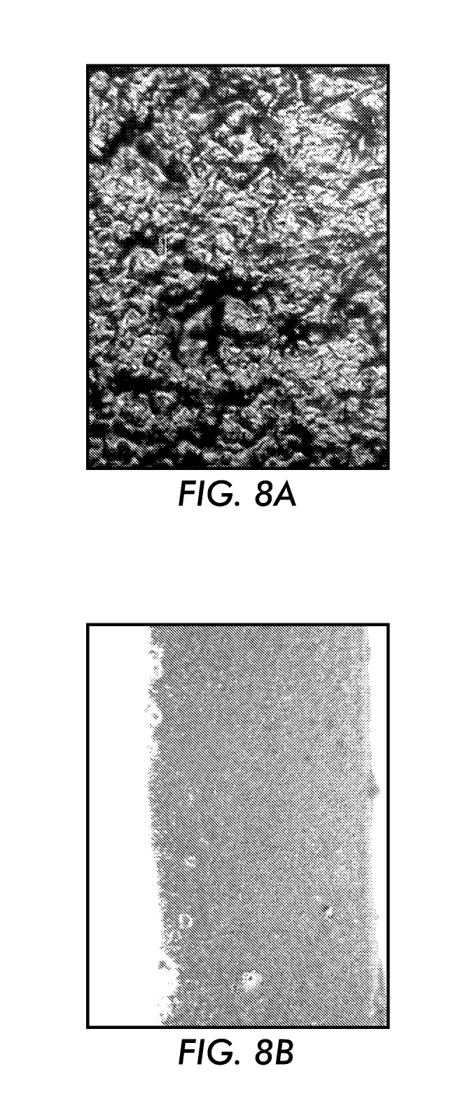

In Example 9, the procedure of Example 8 was followed except that the surface layer further included 10 wt % of carbon black. FIG. 8A is an SEM image of the surface layer. FIG. 8B is a picture of the print using the surface layer shown in FIG. 8A.

### Results and Comparison

From hand testing performed in Examples 7-9, it was indicated that (1) wetting of the fountain solution was efficient; (2) pinning of the fountain solution was improved than on smooth imaging member surfaces that did not include an aerogel component; (3) wetting of the ink was improved compared with smooth imaging member surfaces that did not include an aerogel component, as indicated by better solid area coverage and colour; and (4) transfer of the ink was generally good, as indicated by <10% residual on plate. Homogeneity and completeness of transfer depended on the roughness scale of the plate surface. Finer roughness with a tighter particle size distribution resulted in better homogeneity and surface area coverage.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

What is claimed is:

1. An imaging member comprising a surface layer, wherein the surface layer comprises a matrix material, an aerogel component, and a radiation-absorbing filler.

2. The imaging member of claim 1, wherein the aerogel component comprises a silica aerogel component.

3. The imaging member of claim 1, wherein the radiation-absorbing filler comprises carbon black.

4. The imaging member of claim 1, wherein the aerogel component has a mean particle size of less than about 5 μm.

5. The imaging member of claim 1, wherein the aerogel component has a mean particle size of less than about 1 μm.

6. The imaging member of claim 1, wherein the surface layer comprises from about 0.1 to about 10 wt % of the aerogel component.

7. The imaging member of claim 1, wherein the surface layer comprises from about 1 to about 3 wt % of the aerogel component.

8. The imaging member of claim 1, wherein the surface layer comprises from about 3 to about 10 wt % of the aerogel component.

9. The imaging member of claim 1, wherein the surface layer comprises from about 5 to about 15 wt % of the radiation-absorbing filler.

10. The imaging member of claim 1, wherein the matrix material comprises silicone; wherein the aerogel component comprises a silica aerogel component; and wherein the radiation-absorbing filler comprises carbon black.

11. The imaging member of claim 10, wherein the surface layer comprises from about 0.1 to about 10 wt % of the silica aerogel component and from about 5 to about 15 wt % of the carbon black.

12. The imaging member of claim 1, wherein the matrix material is a silicone, a fluorosilicone, or a fluoroelastomer.

13. The imaging member of claim 1, wherein the aerogel component is hydrophobic.

14. A process for variable lithographic printing, comprising:
applying a fountain solution to an imaging member comprising an imaging member surface;
forming a latent image by evaporating the fountain solution from selective locations on the imaging member surface to form hydrophobic non-image areas and hydrophilic image areas;
developing the latent image by applying an ink composition to the hydrophilic image areas; and
transferring the developed latent image to a receiving substrate;
wherein the imaging member surface comprises a matrix material, an aerogel component, and a radiation-absorbing filler.

15. The process of claim 14, wherein the matrix material comprises silicone; wherein the aerogel component comprises a silica aerogel component; and wherein the radiation-absorbing filler comprises carbon black.

16. The process of claim 15, wherein the surface layer comprises from about 0.1 to about 10 wt % of the silica aerogel component and from about 5 to about 15 wt % of the carbon black.

17. The process of claim 14, wherein the aerogel component has a mean particle size of less than about 3 μm.

18. The process of claim 14, wherein the aerogel component is milled to obtain a mean particle size of less than about 1 μm.

19. The process of claim 14, wherein the matrix material is a silicone, a fluorosilicone, or a fluoroelastomer.

20. The process of claim 14, wherein the aerogel is hydrophobic.
